(19) United States
(12) Patent Application Publication
(10) Pub. No.: US 2025/0026338 A1
(43) Pub. Date: Jan. 23, 2025

(54) CONTROL METHOD FOR SAFE DRIVING IN ZEBRA CROSSING INTERSECTION SCENE

(71) Applicant: BEIJING NATIONAL NEW ENERGY VEHICLE TECHNOLOGY INNOVATION CENTER CO. , LTD., Beijing (CN)

(72) Inventors: Yuxiang ZHOU, Beijing (CN); Dinghai PAN, Beijing (CN); Jun JIANG, Beijing (CN); Chengyin YUAN, Beijing (CN)

(21) Appl. No.: 18/714,273

(22) PCT Filed: Aug. 11, 2022
(86) PCT No.: PCT/CN2022/111850

§ 371 Date: May 29, 2024

(30) Foreign Application Priority Data
Jan. 24, 2022 (CN) 202210076783.6

(51) Int. Cl. B60W 30/09; B60W 10/18; B60W 30/095; B60W 30/18; B60W 50/00; B60W 60/00; H04W 4/44

(52) U.S. Cl. CPC B60W 30/09; B60W 10/18; B60W 30/0956; B60W 30/18154; B60W 50/0097; B60W 60/0015; H04W 4/44; B60W 2554/4029; B60W 2554/4041; B60W 2554/4042; B60W 2554/4045; B60W 2554/4046; B60W 2554/802; B60W 2556/45

(57) ABSTRACT

A control method for safe driving in a zebra crossing intersection scene, comprising: making a trend prediction based on V2X recognition of status information of a pedestrian and surrounding object on the zebra crossing; communicating in real-time with V2X before a vehicle passes through the zebra crossing to obtain the status information of the pedestrian and the surrounding object on the zebra crossing, making a trend prediction and making a judgment, and controlling the vehicle's operation based on the judgment result. Through the fusion perception of the on-board perception technology and the V2X technology, the vehicle obtains the beyond-visual-range perception ability of the environment, perceives the pedestrian and other object on the zebra crossing in advance and predicts their motion trajectories, and the vehicle makes a judgment and responses in advance for potential risk to avoid collision between the vehicle and the pedestrian and other object on the zebra crossing; on the basis of ensuring the safety of traffic participants, the comfort of the driver and passengers is guaranteed to the maximum extent.

### FIELD OF TECHNOLOGY

The present disclosure relates to the technical field of intelligent driving, specifically relates to a control method for safe driving in a zebra crossing intersection scene.

### BACKGROUND

The integration of autonomous driving vehicles, roads, and smart city networking is the current cross-industry development trend. The development and maturity of “intelligent”+“networked”+“big data” cloud platform technology is the technical basis and guarantee for realizing “intelligent vehicle+”.

Intelligent driving technology is one of the core technical fields of intelligent networked vehicles, wherein environmental perception and control decision-making are the core technical bottlenecks of intelligent driving systems. At present, in the field of intelligent driving technology, the system's environmental perception ability is far from mature, which is the bottleneck among technical bottlenecks and the key constraint factor for realizing intelligent driving. It is a long road and process to develop intelligent networked vehicles based on vehicle-road collaboration, realize intelligent driving technology, and solve the problem of super complex and changeable scenes. Although achieving fully automatic driving is the development direction of intelligent networked vehicle technology, this is a long-term goal, and there is still a long way to go to achieve widespread commercial application. Market demand is the decisive factor in promoting technological progress and implementation.

When a vehicle passes through a zebra crossing, it is easy for the vehicle to collide with pedestrians, bicycles, electric vehicles and other objects (for the convenience of description, referred to as a pedestrian and other object in the whole text). The main reason for the collision is that the driver is negligent and fails to observe a pedestrian and other object in time, or when a pedestrian and other object appear, the driver does not have time to react and cannot avoid the collision between the vehicle and a pedestrian and other object.

ADAS is a typical driver assistance system to achieve driving safety. Driver assistance system, such as Autonomous Emergency Braking (AEB), can help prevent such accidents and is the technical basis for realizing autonomous driving, which has been developing rapidly recently and has a huge market. However, although ADAS system products have been applied to the market for many years, the technology is far from mature, and the function and performance of ADAS are severely restricted by the perception ability of the system. Especially in some special dangerous scenarios, ADAS cannot achieve effective collision avoidance. If the detection range in front of the vehicle sensor is blocked by other objects or vehicles, AEB technology often cannot play an effective role. Referring to FIG. 1, taking a typical accident scenario as an example, two vehicles are traveling in the same direction on different lanes of a two-lane road in the same direction. The test vehicle is SV, and the other vehicle is an obstacle vehicle OV (Obstacle Vehicle). There are a pedestrian and other object TO (Target Object) near the zebra crossing area. Vehicle SV passes through the zebra crossing, and the vehicle (or obstacle) in the adjacent lane blocks the sensor detection range. When the vehicle approaches the zebra crossing, a pedestrian and other object suddenly appear in front of it. The vehicle starts AEB urgently, but because the pedestrian and other object are too close to the vehicle when they appear, it is impossible to avoid the collision between the vehicle and the pedestrian and other object. At the same time, emergency braking of the vehicle will produce a large deceleration, resulting in reduced driving comfort for the driver and passengers, and even causing injuries to the driver and passengers.

### SUMMARY

The technical problem to be solved by the present disclosure is to provide a control method for safe driving in a zebra crossing intersection scene that solves the problem of safe passage of a vehicle when passing through a zebra crossing intersection scene through V2X technology and perception fusion technology.

In order to solve the above technical problem, the technical solution adopted by the present disclosure is:
a control method for safe driving in a zebra crossing intersection scene, comprising:
making a trend prediction based on V2X recognition of status information of a pedestrian and surrounding object on the zebra crossing;
communicating in real-time with V2X before a vehicle passes through the zebra crossing to obtain the status information of the pedestrian and the surrounding object on the zebra crossing, making a trend prediction and making a judgment, and controlling the vehicle's operation based on the judgment result.

The beneficial effects of the present disclosure are: through the fusion perception of the on-board perception technology and the V2X technology, the vehicle obtains the beyond-visual-range perception ability of the environment, perceives a pedestrian and other object on the zebra crossing in advance and predicts their motion trajectories, and the vehicle makes a judgment and responses in advance for potential risk to avoid collision between the vehicle and the pedestrian and other object on the zebra crossing; on the basis of ensuring the safety of traffic participants, the comfort of the driver and passengers is guaranteed to the maximum extent.

### BRIEF DESCRIPTION OF THE DRAWINGS

FIG. 1 is a schematic diagram of the zebra crossing intersection scene in the prior art;

FIG. 2 is an information interaction diagram of the control method for safe driving in a zebra crossing intersection scene of the specific embodiment 1 of the present disclosure;

FIG. 3 is a schematic diagram of each symbol passing through the zebra crossing intersection of the present disclosure.

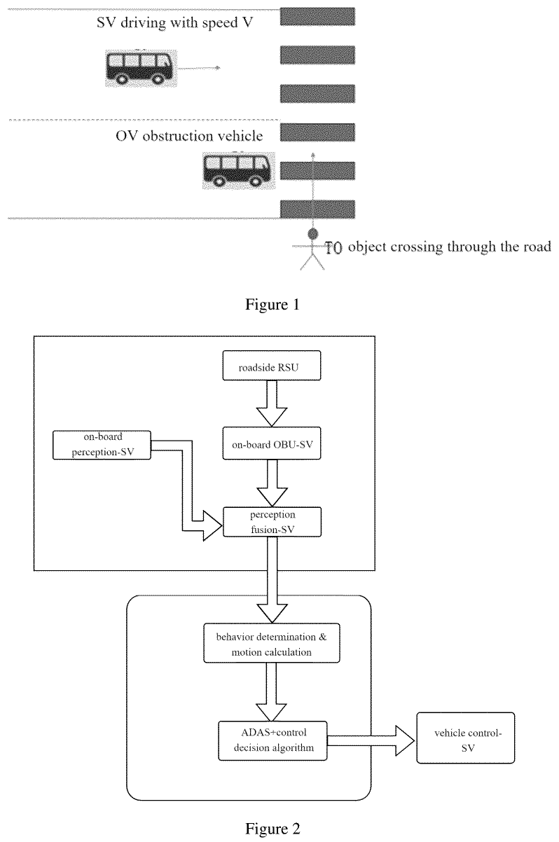

### DESCRIPTION OF THE EMBODIMENTS

In order to explain the technical content, achieved objectives and effects of the present disclosure in detail, the following is an explanation in combination with the implementation methods and accompanying drawings.

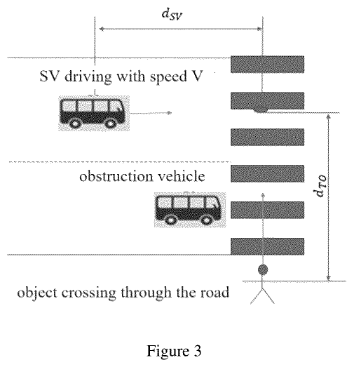

Please refer to FIGS. 2 to 3, a control method for safe driving in a zebra crossing intersection scene, comprising:
making a trend prediction based on V2X recognition of status information of a pedestrian and surrounding object on the zebra crossing;
communicating in real-time with V2X before a vehicle passes through the zebra crossing to obtain the status information of the pedestrian and the surrounding object on the zebra crossing, making a trend prediction and making a judgment, and controlling the vehicle's operation based on the judgment result.

From the above description, it can be seen that through the fusion perception of on-board perception technology and V2X technology, the vehicle obtains the beyond-visual-range perception ability of the environment, perceives a pedestrian and other object on the zebra crossing in advance and predicts their motion trajectories. The vehicle makes a judgment and responses in advance for potential risks to avoid collisions between the vehicle and the pedestrian and other object on the zebra crossing, and on the basis of ensuring the safety of traffic participants, the comfort of the driver and passengers is guaranteed to the maximum extent.

Furthermore, the V2X (wherein X is unknown function) is one or more of Vehicle to Infrastructure (V2I), Vehicle to People (V2P), and Vehicle to Net (V2N).

Furthermore, making a trend prediction based on V2X recognition of status information of a pedestrian and surrounding object on the zebra crossing further comprises:
detecting and identifying the pedestrian and the surrounding object, outputting motion information of the pedestrian and the surrounding object during their movement, comparing whether position coordinates of the pedestrian and the surrounding object at adjacent moments coincide with an area where the zebra crossing is located or the pedestrian and the surrounding object are approaching the area where the zebra crossing is located, to judge whether there is a pedestrian or surrounding object on the zebra crossing, or a pedestrian or surrounding object near the zebra crossing has a tendency to pass through the zebra crossing.

Furthermore, the motion information includes data information of position, speed, and orientation angle.

Furthermore, the judgment result includes alarming, emergency braking or continuing to move forward.

Furthermore, the alarming includes:
when there is a pedestrian on the zebra crossing or when it is judged that a pedestrian or surrounding object has a tendency to pass through the zebra crossing, and meanwhile a distance between the vehicle and the zebra crossing meets a safety distance requirement, it is guaranteed that after a preset time period from occurrence of an early warning, the vehicle can still stop in front of the zebra crossing by mild braking;
the safety distance is a driving distance for the vehicle to achieve a safe stop under the mild braking condition, and a calculation formula of time tₛₜₒₚ for the vehicle to decelerate to stop by mild braking is:

$${t}_{stop} = - \frac{{v}_{SV}}{{a}_{SV}}$$

a calculation formula of a driving distance dₛₜₒₚ for the vehicle to decelerate to stop is:

$${d}_{stop} = \frac{{v}_{SV}^{2}}{2 * \vert {a}_{SV} \vert} + ( {t}_{S V D} + {t}_{R B R} ) * {v}_{S V}$$

wherein the distance between the vehicle and the zebra crossing is d_{SV}, driving speed of the vehicle is v_{SV}, acceleration/deceleration of the vehicle is a_{SV}, reaction time of a vehicle driver is t_{SVD}, reaction lag time of a vehicle braking system is t_{RBR};
a trigger condition of the alarming is there is a pedestrian on the zebra crossing or it is judged that a roadside pedestrian or surrounding object has a tendency to pass through the zebra crossing, and meanwhile when the distance between the vehicle and the zebra crossing d_{SV}<dₛₜₒₚ+dₚᵣₑ₁, a system early alarming is trigged, and when the object disappears, the early alarming is cancelled;
wherein dₚᵣₑ₁ is a preset constant for the early alarming in advance.

Furthermore, the deceleration of the vehicle during the mild braking |a_{SV}| is less than 0.2 g.

Furthermore, the prediction includes whether a pedestrian or surrounding object will collide with the vehicle in a collision area, and a judgment formula is:

$$\frac{{d}_{T O} - ( \frac{{L}_{SV}}{2} + Δ l )}{{v}_{T O}} \leq \frac{{d}_{SV}}{{v}_{S V}} \leq \frac{{d}_{T O} + ( \frac{{L}_{SV}}{2} + Δ l )}{{v}_{T O}}$$

wherein Δl is related to system response deviation of a braking system and a sensor system, and a safety distance;
a walking speed of a pedestrian or surrounding object is v_{TO};
a distance between a pedestrian or surrounding object and a center point of the zebra crossing in a lane where the vehicle is located is d_{TO};
an intersection of the lane where the vehicle is located and the zebra crossing is a collision point, an area centered around the collision point with a width along a direction of the zebra crossing is the collision area, which is preset as an area with width L_{SV} of the lane where the vehicle is located.

Furthermore, the emergency braking includes:
predicting behavior of the pedestrian and the surrounding object, when it is judged that the pedestrian or the surrounding object is in the collision area when the vehicle passes, and meanwhile the distance between the vehicle and the zebra crossing d_{SV} is less than a preset value, performing high-force braking to realize stopping in front of the zebra crossing;
detecting position information and speed information of the pedestrian, judging by the speed information and position information that the pedestrian or the surrounding object will collide with the vehicle in the collision area;
a driving distance Dₛₜₒₚ when the vehicle decelerates to a speed of 0 is:

$${D}_{s t o p} = \frac{{V}_{SV}^{2}}{2 * \vert {a}_{SV} \vert} + ( {T}_{S V D} + {T}_{R B R} ) * {V}_{S V}$$

at current speed of the vehicle v_{SV}, when the vehicle brakes to a speed is 0, the deceleration a_{SV} during braking is calculated by Dₛₜₒₚ=dₛᵥ;
the trigger condition of the emergency braking is condition a plus condition b;
the condition a is that the vehicle, the pedestrian, and the surrounding object pass through a potential collision area within same time window;
the condition b is the deceleration of the vehicle by high-force braking to stop at the current speed.

Furthermore, the deceleration |a_{SV}| of the vehicle during high-force braking is greater than 0.5 g.

### Embodiment 1

A control method for safe driving in a zebra crossing intersection scene, taking V2I (Vehicle to Infrastructure, between the vehicle and road) as an example, V2I is the roadside, and the roadside is equipped with roadside perception (such as cameras and radars), computing equipment (MEC) and real-time communication equipment (RSU) at appropriate locations, which can perceive and identify moving objects (such as pedestrians) within the scene range. V2I interaction information includes but is not limited to information such as the location and status of nearby vehicles, and information such as the status and location of a pedestrian and other object on and near the zebra crossing. The information interaction process is shown in FIG. 2.

The following vehicle is collectively referred to as test vehicle SV.

The test vehicle SV is equipped with an ADAS system with an Autonomous Emergency Braking (AEB) and a sensing device with a V2I device (OBU), such as a visual camera and a millimeter-wave radar, to identify the objects (vehicles and pedestrians, etc.), the location, and the distance and driving speed of the objects in front. The test vehicle SV is equipped with an OBU device (V2X on-board information communication device) to achieve real-time communication and information interaction of V2I with the roadside RSU device.

In this embodiment, the test vehicle SV uses its on-board OBU device and V2I communication to achieve docking with the roadside RSU device, collaboratively senses the status information of the obscured pedestrian and other object in front, and then merges it with the on-board sensing information of the test vehicle. On the one hand, the test vehicle senses the information of the pedestrian in front of the vehicle through its own sensing system, and at the same time, obtains the information of the pedestrian and objects on and around the zebra crossing in a timely manner through V2I. Therefore, when the vehicle passes through the zebra crossing intersection, the system can obtain the information of the pedestrian objects in front in a timely manner, especially the obscured pedestrian objects and status information, make decisions in advance, and take necessary measures in advance, such as alarming or emergency braking. The ultimate goal is to allow the test vehicle SV to slow down or stop safely at the zebra crossing intersection when necessary to protect the safety of a pedestrian and other object on the zebra crossing. To achieve the above system technical goals, the following technical contents are mainly solved: real-time communication of V2I, recognition and behavior prediction of a pedestrian and other object on and near the zebra crossing based on V2I perception fusion, and control decision algorithm of the test vehicle SV.

Preset (FIG. 3 is used as a reference for the following symbols):

The driving speed of the test vehicle SV is v_{SV}.

The walking speed of a pedestrian and other object TO is vₜₒ.

The distance between SV and the zebra crossing is d_{TO}, as shown in the schematic diagram of FIG. 3.

The distance between the pedestrian and other object TO and the center point of the zebra crossing in the lane where SV is located is d_{TO}, as shown in the schematic diagram of FIG. 3.

The acceleration of SV is a_{SV}.

The reaction time of the driver of the test vehicle SV is t_{SVD}, and the reaction lag time of the SV braking system is t_{RBR}.

The intersection of the lane where the test vehicle SV is located and the zebra crossing is the collision point, and the area with a certain width (assuming that the width of the lane where the test vehicle SV is located L_{SV} is taken) along the zebra crossing direction with the collision point as the center is the collision area.

### (1) Prediction and Judgment of the Behavior of a Pedestrian and Other Object

There are a pedestrian and other object on the zebra crossing or the pedestrian and other object near the zebra crossing have a tendency to pass through the zebra crossing:

The sensor detects and identifies the pedestrian and other object in real time, and outputs the motion information of the pedestrian and other object during their movement, including data information such as position, speed, and orientation angle. By comparing whether the position coordinates of the pedestrian and other object at adjacent moments coincide with the area where the zebra crossing is located or the pedestrian and the surrounding object are approaching the zebra crossing area, it is judged that there are pedestrian and other object on the zebra crossing or the pedestrian and other object near the zebra crossing have a tendency to pass through the zebra crossing.

A pedestrian and other object will collide with the vehicle in the collision area:

The sensor detects a pedestrian and other object in real time, and by analyzing the position information of the pedestrian and other object at different moments, it is judged whether the pedestrian and other object will collide with the vehicle in the collision area.

$$\frac{{d}_{T O} - ( \frac{{L}_{SV}}{2} + Δ l )}{{v}_{TO}} \leq \frac{{d}_{SV}}{{v}_{SV}} \leq \frac{{d}_{T O} + ( \frac{{L}_{SV}}{2} + Δ l )}{{v}_{TO}}$$

wherein Δl is related to system response deviation of systems such as a braking system and a sensor system, and is related to a safety distance.

### (2) Vehicle Control Decision Logic

The sensor detects a pedestrian and other object in real time, and by analyzing the speed information and position information of the pedestrian and other object at different moments, it is determined whether there are a pedestrian and other object on the zebra crossing, whether the pedestrian and other object near the zebra crossing have a tendency to pass through the zebra crossing, and whether the pedestrian and other object will collide with the vehicle in the collision area, and then the vehicle is controlled to take necessary measures in advance, such as vehicle early warning and vehicle emergency braking.

### a) Pedestrian Warning

The triggering principle of early warning is that when there is a pedestrian on the zebra crossing, or when it is judged that roadside pedestrian and other object have a tendency to pass through the zebra crossing, the test vehicle SV is far enough away from the zebra crossing to ensure that it can stop in front of the zebra crossing by mild braking after a certain period of time from occurrence of the early warning.

### \textcircled{1} Calculation of Early Warning Distance

Setting method for safety distance: the test vehicle can achieve safe stop under the condition of mild deceleration (for example, |a_{SV}|0.2 g, this value can be adjusted and optimized as needed).

Motion estimation of the test vehicle SV (under mild braking condition, control target), the time from decelerating to stopping tₛₜₒₚ is:

$${r}_{stop} = - \frac{{v}_{S V}}{{a}_{S V}}$$

(wherein for example, a_{SV}=0.2 g or other proper values)

The driving distance dₛₜₒₚ for SV from decelerating to stopping is:

$${d}_{stop} = \frac{{v}_{SV}^{2}}{2 * \vert {a}_{SV} \vert} + ( {t}_{S V D} + {t}_{R B R} ) * {v}_{S V}$$

### \textcircled{2} Triggering Conditions of Early Warning

When there is a pedestrian on the zebra crossing, or when it is judged that roadside pedestrian and other object have a tendency to pass through the zebra crossing, and the distance between the test vehicle SV and the lane line d_{SV}<dₛₜₒₚ+dₚᵣₑ₁, a system early warning is triggered. When the object disappears, the early warning is cancelled, wherein dₚᵣₑ₁ is a preset constant for the early alarming in advance (for example, 25 m, the specific value can be adjusted and optimized as needed).

### B) Autonomous Emergency Braking (AEB)

Principle of triggering AEB: predicting the behavior of the pedestrian and other object, when it is judged that the pedestrian and other object are in the possible collision area when the vehicle passes, and the distance between the vehicle and the zebra crossing d_{SV} is small, high-intensity braking (for example, deceleration |a_{SV}|>0.5 g) is required for the vehicle to stop before the zebra crossing.

### \textcircled{1} Calculation of Pedestrian Position

The sensor detects the position information and speed information of the pedestrian in real time, and it is judged that the pedestrian and other object will collide with the vehicle in the collision area through the speed and position information.

$$\frac{{d}_{T O} - \frac{{L}_{SV}}{2}}{{v}_{T O}} \leq \frac{{d}_{SV}}{{v}_{SV}} \leq \frac{{d}_{T O} + \frac{{L}_{SV}}{2}}{{v}_{T O}}$$

\textcircled{2} Calculation of braking deceleration when the vehicle brakes to the speed of 0 under the current vehicle speed v_{SV}:
Driving distance Dₛₜₒₚ when SV decelerates to the speed of 0:

$${D}_{stop} = \frac{{V}_{SV}^{2}}{2 * \vert {a}_{SV} \vert} + ( {T}_{S V D} + {T}_{R B R} ) * {V}_{S V}$$

From Dₛₜₒₚ=d_{SV}, a_{SV} can be calculated.
Condition of triggering AEB: condition a plus condition b;
condition a: the vehicle and the pedestrian and other object pass through a potential collision area within same time window;

$$\frac{{d}_{T O} - \frac{{L}_{SV}}{2}}{{v}_{T O}} \leq \frac{{d}_{SV}}{{v}_{SV}} \leq \frac{{d}_{T O} + \frac{{L}_{SV}}{2}}{{v}_{T O}}$$

condition b: the deceleration |a_{SV}| by braking to stop at the current speed of the vehicle is greater than 0.5 g.

In summary, the control method for safe driving in the zebra crossing intersection scene provided by the present disclosure is based on V2I technology (the same applies to other V2X technologies), and obtains more accurate and reliable all-weather pedestrian and object perception information around the zebra crossing through the fusion of on-board perception and roadside perception information; based on perception fusion and target recognition, the behavior of the pedestrian and object near the zebra crossing scene is analyzed and predicted; the control decision algorithm aims to protect pedestrians and avoid collisions, while taking advantage of V2I perception fusion and pedestrian behavior prediction, taking into account the comfort and smoothness of vehicle control. The algorithm is suitable for the application of ADAS and automatic driving systems; the vehicle speed control strategy performs real-time dynamic calculation and optimization through the motion state of the vehicle and the motion state of pedestrians.

The above is only an embodiment of the present disclosure, and does not limit the patent scope of the present disclosure. Any equivalent transformation made using the contents of the specification and drawings of the present disclosure, or directly or indirectly used in related technical fields, is also included in the patent protection scope of the present disclosure.

What is claimed is:

1. A control method for safe driving in a zebra crossing intersection scene, comprising:
making a trend prediction based on V2X recognition of status information of a pedestrian and surrounding object on the zebra crossing;
communicating in real-time with V2X before a vehicle passes through the zebra crossing to obtain the status information of the pedestrian and the surrounding object on the zebra crossing, making a trend prediction and making a judgment, and controlling the vehicle's operation based on a result of the judgment.

2. The control method for safe driving in a zebra crossing intersection scene according to claim 1, wherein the V2X is one or more of Vehicle to Infrastructure (V2I), Vehicle to People (V2P), and Vehicle to Net (V2N).

3. The control method for safe driving in a zebra crossing intersection scene according to claim 1, wherein making a trend prediction based on V2X recognition of status information of a pedestrian and surrounding object on the zebra crossing comprising:
detecting and identifying the pedestrian and the surrounding object, outputting motion information of the pedestrian and the surrounding object during their movement, comparing whether position coordinates of the pedestrian and the surrounding object at adjacent moments coincide with an area where the zebra crossing is located or the pedestrian and the surrounding object are approaching the area where the zebra crossing is located, to judge whether there is a pedestrian or surrounding object on the zebra crossing, or a pedestrian or surrounding object near the zebra crossing has a tendency to pass through the zebra crossing.

4. The control method for safe driving in a zebra crossing intersection scene according to claim 3, wherein the motion information includes data information of position, speed, and orientation angle.

5. The control method for safe driving in a zebra crossing intersection scene according to claim 1, wherein the result of the judgment includes alarming, emergency braking or continuing to move forward.

6. The control method for safe driving in a zebra crossing intersection scene according to claim 5, wherein the alarming includes:
when there is a pedestrian on the zebra crossing or when it is judged that a pedestrian or surrounding object has a tendency to pass through the zebra crossing, and meanwhile a distance between the vehicle and the zebra crossing meets a safety distance requirement, it is guaranteed that after a preset time period from occurrence of an early warning, the vehicle can still stop in front of the zebra crossing by mild braking;
the safety distance is a driving distance for the vehicle to achieve a safe stop under a mild braking condition, and a calculation formula of time tₛₜₒₚ for the vehicle to decelerate to stop by mild braking is:
$${t}_{stop} = - \frac{{v}_{SV}}{{a}_{SV}}$$
a calculation formula of a driving distance dₛₜₒₚ for the vehicle to decelerate to stop is:
$${d}_{stop} = \frac{{v}_{SV}^{2}}{2 * \vert {a}_{SV} \vert} + ( {t}_{S V D} + {t}_{R B R} ) * {v}_{S V}$$
wherein the distance between the vehicle and the zebra crossing is d_{SV}, driving speed of the vehicle is v_{SV}, acceleration/deceleration of the vehicle is a_{SV}, reaction time of a vehicle driver is t_{SVD}, and reaction lag time of a vehicle braking system is t_{RBR};
a trigger condition of the alarming is there is a pedestrian on the zebra crossing or it is judged that a roadside pedestrian or surrounding object has a tendency to pass through the zebra crossing, and meanwhile when the distance between the vehicle and the zebra crossing d_{SV}<dₛₜₒₚ+dₚᵣₑ₁, a system early alarming is trigged, and when the object disappears, the early alarming is cancelled;
wherein dₚᵣₑ₁ is a preset constant for the early alarming in advance.

7. The control method for safe driving in a zebra crossing intersection scene according to claim 6, wherein the deceleration of the vehicle during the mild braking |a_{SV}| is less than 0.2 g.

8. The control method for safe driving in a zebra crossing intersection scene according to claim 5, wherein the prediction includes whether a pedestrian or surrounding object will collide with the vehicle in a collision area, and a judgment formula is:
$$\frac{{d}_{T O} - ( \frac{{L}_{SV}}{2} + Δ l )}{{v}_{T O}} \leq \frac{{d}_{SV}}{{v}_{S V}} \leq \frac{{d}_{T O} + ( \frac{{L}_{SV}}{2} + Δ l )}{{v}_{T O}}$$
wherein Δl is related to system response deviation of a braking system and a sensor system, and a safety distance;
a walking speed of a pedestrian or surrounding object is v_{TO};
a distance between a pedestrian or surrounding object and a center point of the zebra crossing in a lane where the vehicle is located is d_{TO};
an intersection of the lane where the vehicle is located and the zebra crossing is a collision point, an area centered around the collision point with a width along a direction of the zebra crossing is the collision area, which is preset as an area with width L_{SV} of the lane where the vehicle is located.

9. The control method for safe driving in a zebra crossing intersection scene according to claim 8, wherein the emergency braking includes:
predicting behavior of the pedestrian and the surrounding object, when it is judged that the pedestrian or the surrounding object is in the collision area when the vehicle passes, and meanwhile the distance between the vehicle and the zebra crossing d_{SV} is less than a preset value, performing high-force braking to realize stopping in front of the zebra crossing;
detecting position information and speed information of the pedestrian, judging by the speed information and position information that the pedestrian or the surrounding object will collide with the vehicle in the collision area;
a driving distance Dₛₜₒₚ when the vehicle decelerates to a speed of 0 is:
$${D}_{stop} = \frac{{V}_{SV}^{2}}{2 * \vert {a}_{SV} \vert} + ( {T}_{S V D} + {T}_{R B R} ) * {V}_{S V}$$
at current speed of the vehicle v_{SV}, when the vehicle brakes to a speed of 0, the deceleration a_{SV} during braking is calculated by Dₛₜₒₚ=dₛᵥ;
a trigger condition of the emergency braking is condition a plus condition b;
the condition a is that the vehicle and the pedestrian or the surrounding object pass through a potential collision area within same time window;
the condition b is the deceleration of the vehicle by high-force braking to stop at the current speed.

10. The control method for safe driving in a zebra crossing intersection scene according to claim 9, wherein the deceleration |a_{SV}| of the vehicle during high-force braking is greater than 0.5 g.
